(19) United States
(12) Patent Application Publication
(10) Pub. No.: US 2007/0196683 A1
(43) Pub. Date: Aug. 23, 2007

(54) Method for casting reactive metals and casting containers associated therewith

(76) Inventors: Max Eric Schlienger, American Canyon, CA (US); Michael Baldwin, American Canyon, CA (US); Michael Maguire, Napa, CA (US)

Correspondence Address: KRIEG DEVAULT LLP, ONE INDIANA SQUARE, SUITE 2800, INDIANAPOLIS, IN, 46204-2079, US

(21) Appl. No.: 11/653,739

(22) Filed: Jan. 16, 2007

Related U.S. Application Data
(63) Continuation of application No. PCT/US06/26783, filed on Jul. 10, 2006.
(60) Provisional application No. 60/697,677, filed on Jul. 8, 2005.

(51) Int. Cl. B05D 3/04; B05D 3/02; B05D 1/18; B32B 3/10

(52) U.S. Cl. 428/596; 427/443.2; 427/372.2; 427/496; 427/508; 427/334; 428/660; 428/131

(57) ABSTRACT

An investment casting system for producing a cast article from a reactive metal that is free of an undesirable surface layer generally associated with the reaction between the molten metal and the casting mold. In one form the casting mold is substantially free of silica. A silica free ceramic crucible for heating and holding molten reactive metal is also contemplated herein.

### CROSS-REFERENCE TO RELATED APPLICATIONS

The present application claims the benefit of U.S. Provisional Patent Application No. 60/697,677, filed on Jul. 8, 2005, which is incorporated herein by reference.

### BACKGROUND

The present invention relates generally to molds and crucibles utilized in casting reactive metals, such as but not limited to titanium, zirconium, uranium and nickel based alloys containing rare earth elements. More particularly, the present invention relates to crucibles and molds that are substantially non-reactive or of a low reactive level.

In the production of investment cast components the high temperature molten metal is in contact with the molds and crucibles. In many metal or alloy systems there is a reaction between the mold and/or crucible and the metal being cast. As an example, in the casting of titanium the metal-mold reaction is often referred to as alpha case and generally requires the surface of the resultant cast item to be reworked by etching, polishing or other processes. In the case of nickel based alloys containing rare earth elements the metal-mold/oxidation reaction is often referred to as alloy depletion. More specifically, the reaction between the metal & mold can deplete the rare earth elements out of the nickel alloy.

Presently, many casting systems utilized for casting reactive metals have a variety of shortcomings, drawbacks and disadvantages. Accordingly, there is a need for the unique and inventive casting systems and methods according to the present invention.

### SUMMARY

One embodiment according to the present invention is a unique molten metal casting system for a reactive metal. Other embodiments include unique apparatuses, systems, devices, hardware, methods, and combinations of these for the production of cast components from a reactive metal. Further embodiments, forms, objects, features, advantages, aspects, and benefits of the present invention shall become apparent from the following description and drawings.

### BRIEF DESCRIPTION OF THE DRAWINGS

FIG. 1 is a non-limiting example of a cast component.

FIG. 2 is another non-limiting example of a cast component.

FIG. 3 is an illustrative view of a reactive molten metal within a container for the molten metal.

FIG. 4 is an illustrative sectional view of a portion of a cast component formed of a reactive metal.

FIG. 5 is an illustrative view of a stereolithography process for producing a molten metal container.

FIG. 6 is an illustrative view of a molten metal container being fired in a furnace.

FIG. 7 is an illustrative view of molten metal being poured into a molten metal container.

### DESCRIPTION OF THE ILLUSTRATIVE EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention is illustrated therein being contemplated as would normally occur to one skilled in the art to which the invention relates.

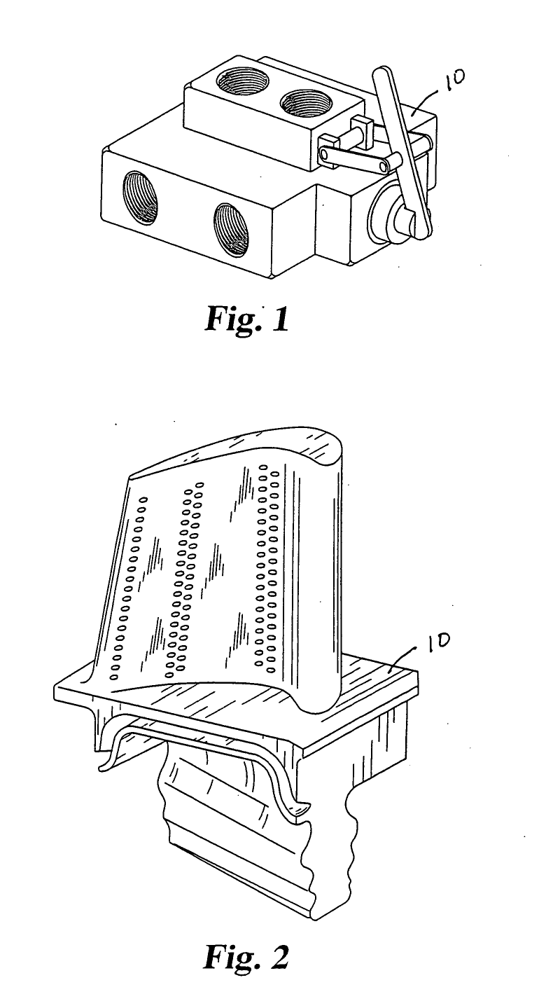

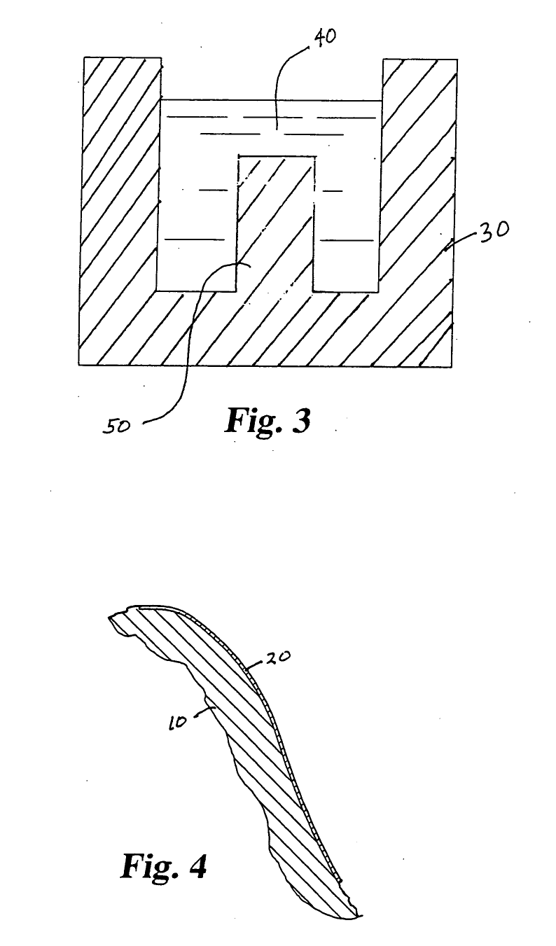

With reference to FIGS. 1 and 2, there are illustrated non-limiting examples of components 10 that could be produced with the present inventions. The products illustrated herein are not intended to be limiting and other cast products are contemplated for production by the present invention including, but not limited to art, jewelry, dental prosthesis, general prosthesis, custom hardware, golf club heads, propellers, electronic packaging, tubes, valves and other items that have been traditionally investment cast. More specifically, the present inventions relate to casting of components from reactive metals. The term “reactive metal” as used herein means any metal that can be cast by the investment casting process and is reactive with the casting molds and or crucible materials. The reactive metals are materials which as a result of being cast with a traditional casting process may develop an undesirable surface layer on the resulting cast component. Examples of reactive metals include, but are not limited to titanium, zirconium, uranium and nickel-based alloys containing rare earth metals. However, other types and alloys of reactive metals are contemplated herein With reference to illustrative FIGS. 3 and 4, there will be described attributes of the present inventions. The inventors of the present application have discovered that they can reduce or eliminate an undesirable surface layer 20 of the cast component 10 that generally develops due to the interaction/oxidation reaction between the prior casting mold systems and the molten reactive metals 40. In one form the undesirable surface layer 20 may be manifested as an alternative material phase. In one form, generally associated with titanium, the undesirable surface layer associated with the molten reactive metal-mold reaction is an oxidation reaction that is often referred to as alpha case. In the case of nickel based alloys containing rare earth elements there is an undesirable surface layer associated with the localized alloy depletion. More specifically, this molten reactive metal-mold reaction is an oxidation reaction that depletes a portion of the rare earth elements out of the nickel alloy casting. The traditional approach to dealing with the undesirable surface layers was to rework them by etching, polishing or other processes.

One embodiment of the present invention contemplates that the high temperature reactive metal is at a temperature greater than 1500° C. during the casting process. However, other casting temperatures are fully contemplated herein. In one form the resulting cast parts are removed from the casting molds substantially free from any undesirable surface layer associated with the molten reactive metal-mold reaction. In another form of the present invention the undesirable surface layer associated with the molten reactive metal-mold reaction is completely eliminated. In general, although the undesirable surface layer is a function of the mold and time at temperature (and hence section thickness) the present invention provides for reduction in the undesirable surface layer thickness relative to the prior technology.

The present application contemplates that casting containers include, but are not limited to molds 30 and crucibles 70 (FIG. 7). The term mold should be read broadly to include a container for receiving a molten material therein that is solidified into a part or component. The mold 30 may or may not include casting cores 50. Cores are provided in some molds to form internal details within the cast component. In one form the core 50 is integrally formed with the mold 30, however separate cores are also contemplated herein. The illustrated core 50 is purely illustrative and is not intended to limit the meaning of cores; which the present application considers may vary in the continuum between being very complex to being very simple. Molds 30 contemplated herein may form any type of shaped object/component/product. For example, the objects/components/product may be a simple flat object or of a three dimensional shape that may be simple or complex. Further, in considering the object/component/product produced it may have a complex series of internal cores 50 with a complex three dimensional internal passage defined or it may have a simple internal passage or no internal passages.

The mold 30 of the present invention may also be utilized in an auxiliary external reinforced mode provided the auxiliary external reinforcement is substantially free of silica. Examples of mold reinforcement 80 (FIG. 7) include the external abutment of the mold 30 with solid material reinforcement, external abutment of the mold 30 with particulate material reinforcement and/or reinforcement by placing the mold 30 within a tube and filling around the mold with reinforcing balls/members. As shown in the purely representative FIGS. 1 and 2 a variety of shapes and types of components are contemplated herein. Additionally, the present application contemplates the use of the mold 30 in a non auxiliary external reinforced mode or in an auxiliary external reinforced mode.

The term crucible should be read broadly to define a container for melting and holding metals. As the reader should understand crucibles 70 are generally formed to withstand a very hostile environment associated with the melting, holding and pouring of the molten reactive metal over a prolonged period of use. The crucible will have an internal volume 71 for the holding and melting of the reactive metal. The present invention contemplates that in general molds 30 are in contact with the molten reactive metal for a period of time that is measured in minutes to tens of minutes and crucibles 70 are in contact with the molten reactive metal for hours to tens of hours. However, the present application contemplates that the time for molten reactive metal contact with the mold 30 and/or crucible 70 is not limited by these times and other periods of time are contemplated herein. The description provided herein will generally be in terms of a mold; however the description is also generally applicable to a crucible.

The present application is directed to molds 30 and/or crucibles 70 formed of materials that are substantially free of silica. The present inventions further contemplate the fabrications/production of other components and tools by the present inventions. Examples of other components and tools contemplated herein include: Titanium/Alumina composite dental crowns, proton exchange membranes for fuel cells, molten metal handling components such as tubes, nozzles, atomizers etc. In another form of the present invention the molds 30 and/or crucibles 70 are formed of a high purity ceramic material; that is a ceramic material that may include low levels of silica impurities. In yet another form of the present invention the molds 30 and/or crucibles 70 are completely free of silica. Examples of ceramic materials suitable for making molds 30 and/or crucibles 70 of the present invention include, but are not limited to zirconia, alumina and yttria and combinations thereof. However, other types of low reactive/non reactive ceramic materials are contemplated herein. The present application contemplates that non-reactive ceramics may be included in the category of low reactive ceramics, unless specifically provided to the contrary.

The present application is directed to the formation of a casting mold 30 and/or crucible 70 for casting materials therein including reactive metals. The mold 30 and/or container and/or crucible 70 are formed from a mixture including a ceramic material and a polymer based sacrificial binder. The polymer based binder is burned out during the firing/processing of the casting mold 30 and/or crucible 70. As discussed above the mixture is at least substantially free of silica material. The absence of silica material includes the avoidance of silica as a ceramic material and the avoidance of any silica to be used as a binder. In many traditional ceramic casting molds there is utilized colloidal silica as a binder. In one form the present application utilizes the polymer based sacrificial binder in place of the silica binder.

The present inventions contemplate the utilization of the ceramic mixtures including a high purity ceramic material and catalytic, heat or laser activated polymeric binders to form a casting mold and/or crucible. The casting mold and/or crucible produced are silica free low reactivity mold. Several fabrication techniques are contemplated for creating the casting mold and/or crucible including: stereolithography, paste ceramic stereolithography and gel casting. Slip casting with organic catalytically activated binders is also contemplated herein. Further, the present application contemplates an alternative embodiment wherein the casting mold is not formed by a free form fabrication technique but rather by the traditional dipping of the pattern (the pattern may be formed by traditional wax injection, machining, free form fabrication or any other technique.) into a liquid mixture composed of the high purity ceramic material and a polymeric binder that are substantially free of silica.

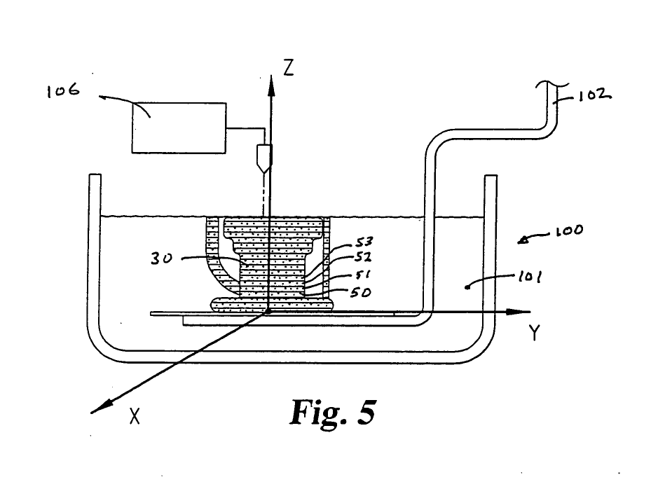

With reference to FIG. 5, there is illustrated one embodiment of a casting mold 30 being formed by a ceramic stereolithography process. Ceramic stereolithography as utilized herein should be broadly construed and includes the utilization of ceramic material within a photo-polymerizabele resin. The mold 30 is merely illustrative and is shown being formed by the photo-polymerization of the ceramic filled resin into layers (e.g. 50, 51, 52, 53) of ceramic particles that are held together by a polymer binder. The reader should understand that there is no intention herein to limit the present application to any particular number of layers unless specifically provided to the contrary.

Stereolithography apparatus 100 is illustrated in a simplified manner to facilitate the explanation of one method of making mold 30. In one form the formation of the layers (e.g. 50-53) utilizes a leveling technique to level each of the layers of photo-polymerizable ceramic filled resin prior to receiving a dose of energy.

In one form stereolithography apparatus 100 includes a fluid/resin containment reservoir 101, an elevation-changing member 102, and a laser 106. The reservoir 101 is filled with a quantity of the photocurable ceramic filled resin from which the mold 30 is fabricated. Mold 30 is illustrated being fabricated in layer by layer fashion in the stereolithography apparatus 100 in the direction of axis Z; which is referred to as the build direction.

In one form the casting mold 30 and/or crucible 70 is formed in a layer (i.e. 50-53) wise fashion with the stereolithography equipment 100. The stereolithography equipment 100 is utilized with low reactive/non reactive ceramic slurry which is selectively cured by the scanning laser to form a green state casting mold 30 and/or crucible 70. In one form the mold has a wall thickness of about 0.080″ thick and a layer thickness of about 0.004 inches. However, other wall and layer thicknesses are contemplated herein. In one respect the green state casting mold and/or crucible are rinsed to remove any excess liquid and dried.

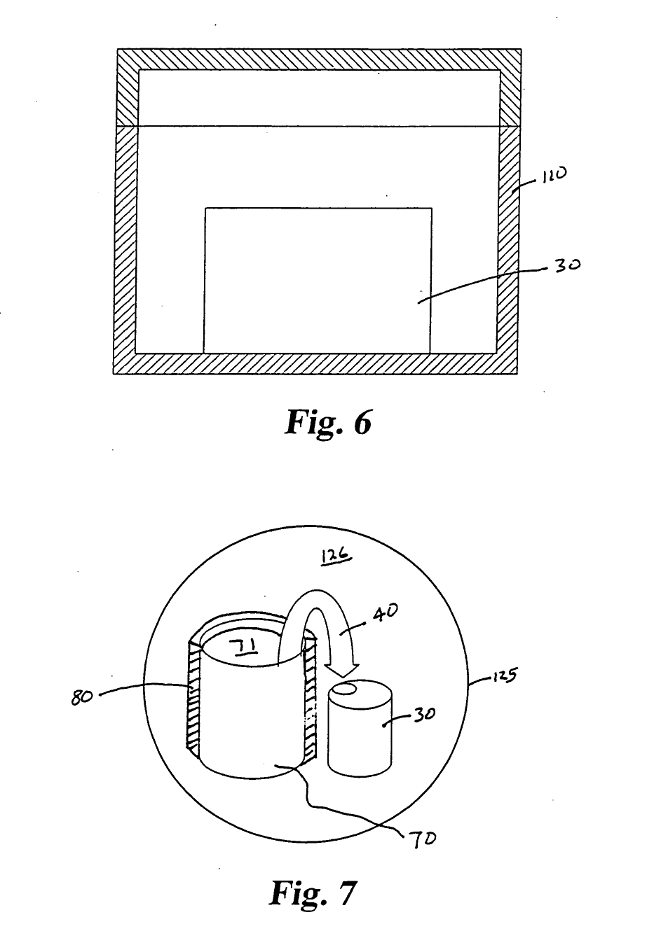

With reference to FIG. 6, there is illustrated the green state casting mold 30 and/or crucible 70 being heated within a furnace 110 to remove the polymeric binder and/or sinter the ceramic particles together. The heating may involve a sintering cycle to create a sintered mold 30 and/or crucible 70 having a density greater than sixty percent of theoretical density. In one form the density is greater than ninety percent and in another form the density is greater than 95% of theoretical density. In yet another form the green state casting mold 30 and/or crucible 70 is sintered to about the theoretical density of the ceramic material. In another form the green state casting mold 30 and/or crucible 70 is sintered to at least 90% of theoretical density. The present application contemplates other densities and that in certain applications the casting mold and/or the crucible may be used in an unfired state.

With reference to FIG. 7, there is depicted a functional representation of a crucible 70 for delivering a charge of molten reactive metal 40 to the casting mold 30. The delivery of the molten metal 40 from the crucible 70 to the casting mold 30 is occurring within a furnace 125. In one form of the present invention the furnace 125 is defined by a vacuum furnace. However, it is understood that other types of furnaces such as, but not limited to, air melt or pressurized casting furnaces are contemplated herein. In a preferred form of the present invention the environment 126 within the furnace 125 is substantially free of silica material, silica gas and byproducts associated with the silica material and/or silica gas. The casting mold 30 and/or the crucible 70 are preferably utilized in the sintered/hardened state within the furnace 125. The molten reactive metal 40 is delivered into the mold 30 and solidified into the cast component. The reader will understand that after solidification of the cast component casting cores may need to be removed.

One form of the present invention contemplates that the mixture utilized for formation of the molds and/or crucibles by stereolithography includes: 1)high purity, low reactive ceramics made from zirconia, alumina or yttria; 2) polymer-based sacrificial binder (monomer(s)); (3) photoinitiators; and 4) dispersant(s). The mixture utilized for the formation of the molds and or crucibles is substantially free of silica. In a preferred form the polymer based sacrificial binder is substantially free of silica and more preferably is free of silica. In one form the loading of ceramic materials within the mixture is contemplated within a range of 35% to 65% by volume. In one example alumina is selected as the sinterable ceramic material. The alumina can be provided as a dry powder having an average powder size suitable for sintering to provide an item having desired characteristics. In one form the powdered alumina has an average particle size within a range of about 0.1 microns to about 5.0 microns. In another form the powdered alumina is selected to have an average particle size within a range of about 0.5 microns to about 1.0 microns. However, other particle sizes for the alumina material are contemplated herein.

The monomer is selected from any suitable monomer that can be induced to polymerize when irradiated in the presence of a photoinitiator. Examples of monomers include acrylate esters and substituted acrylate esters. A combination of two or more monomers may be used. Preferably at least one of the monomers is a multifunctional monomer. By multifunctional monomer it is understood that the monomer includes more than two functional moieties capable of forming bonds with a growing polymer chain. Specific examples of monomers that can be used with this invention include 1,6-hexanediol diacrylate (HDDA) and 2-phenoxyethyl acrylate (POEA). In one form the photocurable monomers are present in an amount between about 10 wt % to about 40 wt %, and in another form about 10 wt % to about 35 wt % , and in yet another form about 20 wt % to 35 wt % based upon the total weight of the mixture. However, the present application contemplates other amounts of monomers.

The dispersant is provided in an amount suitable to maintain a substantially uniform colloidal suspension of the alumina in the mixture. The dispersant can be selected from a wide variety of known surfactants. Dispersants contemplated herein include, but are not limited to, ammonium salts, more preferably tetraalkyl ammonium salts. Examples of dispersants for use in this invention include, but are not limited to: polyoxypropylene diethyl-2-hydroxyethyl ammonium acetate, and ammonium chloride. In one form the amount of dispersant is between about 1.0 wt % and about 10 wt % based upon the total weight of the ceramic within the mixture. However, the present application contemplates other amounts of dispersants.

The initiator is selected from a number of commercially available photoinitiators believed known to those skilled in the art. The photoinitiator is selected to be suitable to induce polymerization of the desired monomer when irradiated. Typically the selection of a photoinitiator will be dictated by the wavelength of radiation used to induce polymerization. Photoinitiators contemplated herein include, but are not limited to benzophenone, trimethyl benzophenone, 1-hydroxycyclohexyl phenyl ketone, isopropylthioxanthone, 2-methyl-1-[4 (methylthio)phenyl]-2-morpholinoprophanone and mixtures thereof. The photoinitiator is added in an amount sufficient to polymerize the monomers when the mixture is irradiated with radiation of appropriate wavelength. In one form the amount of photoinitiator is between about 0.05 wt % and about 5 wt % based upon the total weight of the monomer within the mixture. However, other amounts of photoiniators are contemplated herein.

In an alternate form of the mixture a quantity of a nonreactive diluent is substituted for a quantity of the monomer. In one form the amount of substituted nonreactive diluent is equal to between about 5% and about 20% (by weight) of the monomer in the mixture. However, the present application contemplates that other amounts of non-reactive diluents are considered herein. An illustration of a given ceramic mixture composition requires 100 grams of a monomer that in the alternate form will replace about 5-20 wt % of the monomer with a nonreactive diluent (i.e. 95-80 grams of monomer +5-20 grams of nonreactive diluent). The nonreactive diluent includes but is not limited to a dibasic ester or a decahydronaphthalene. Examples of dibasic esters include dimethyl succinate, dimethyl glutarate, and dimethyl adipate, which are available in a pure form or a mixture.

The mixture is prepared by combining the monomer, the dispersant and the sinterable ceramic to form a homogeneous mixture. Although the order of addition is not critical to this invention typically, the monomer and the dispersant are combined first and then the sinterable ceramic is added. In one form the sinterable ceramic material is added to the monomer/dispersant combination in increments of about 5 to about 20 vol. %. Between each incremental addition of the ceramic material, the resulting mixture is thoroughly mixed by any suitable method, for example, ball milling for about 5 to about 120 minutes. When all of the sinterable ceramic material has been added, the resulting mixture is mixed for an additional amount of time up to 10 hours or more. The photoinitiator is added and blended into the mixture.

With reference to Table I there is set forth one example of an alumina filled mixture. However, the present application is not intended to be limited to the specific composition set forth below unless specifically stated to the contrary.

| | wt/g | vol cc | wt % | vol % |
|---|---|---|---|---|
| Alumina | 1980 | 500 | 78.2 | 48.0 |
| Monomer | 510 | 500 | 20.1 | 48.0 |
| Dispersant | 39.6 | 38.8 | 1.56 | 3.73 |
| Photoinitiator | 2.55 | 2.32 | 0.101 | 0.223 |
| Total | 2532 | 1041 | 100% | 100% |

One form of the present invention contemplates a method for forming a cast component comprising: providing a mixture including high-purity ceramic particles and a curable liquid polymer based binder, wherein the mixture is substantially free of silica; exposing selective areas of the mixture to an energy dose from a laser to form a layer built green solid casting container; sintering the green casting container to adhere the adjacent ceramic particles and burn out the polymer binder to create a hardened ceramic casting container free of silica; pouring a reactive molten metal within the hardened ceramic casting container; and solidifying the reactive molten metal to a cast component substantially free of defects associated with a reaction between the hardened ceramic casting container and the reactive molten metal. Another form of the present method includes that said exposing is carried out with multiple exposures to laser light. In yet another form of the present invention in said providing the high purity ceramic particles are particles of alumina and/or zirconia. In yet another form of the present invention in said exposing forms a green solid casting container including an interior volume including a complex three dimensional shape. In yet another form of the present invention said exposing forms a green solid casting container including at least one casting core. In yet another form of the present invention said exposing forms a green solid casting container including at least one casting core and at least one casting core is integrally formed with said green solid casting container. In yet another form of the present invention the hardened ceramic casting container is a mold. In yet another form of the present invention the defects that the cast component is substantially free of are alpha case defects. In yet another form of the present invention the defects that the cast component is substantially free of are alloy depletion defects.

Another form of the present invention contemplates a method for forming a cast component comprising: providing a mixture including ceramic particles and a curable liquid polymer based binder; forming a green solid casting mold from the mixture; sintering the green casting mold to adhere the adjacent ceramic particles and burn out the polymer binder to create a sintered ceramic casting mold free of silica; pouring a reactive molten metal within the sintered ceramic casting mold; and solidifying the reactive molten metal to a cast component substantially free of surface defects associated with a reaction between the ceramic and the reactive molten metal. In another form of the present invention said forming includes paste ceramic stereolithography. In yet another form of the present invention said forming includes gel casting. In yet another form of the present invention said forming includes stereolithography. In yet another form of the present invention said forming produces a green solid casting mold including an interior volume having at least a portion with a complex three dimensional shape. In yet another form of the present invention said forming produces a green solid casting mold including an interior volume having at least one portion that is not of a simple flat shape. In yet another form of the present invention said forming produces a green solid casting mold including at least one casting core. In yet another form of the present invention said forming produces a green solid casting mold including at least one casting core and said at least one casting core is integrally formed with said green solid casting mold. In yet another form of the present invention the surface defects that the cast component is substantially free of are alpha case defects. In yet another form of the present invention the cast component is substantially free of alloy depletion defects.

Another form of the present invention contemplates an article, comprising: an integrally cast titanium main body having and outer surface and at least one integrally formed internal opening therein, said outer surface as cast being substantially free of alpha case defects. In yet another form of the present invention contemplates said outer surface having at least a portion including a substantially complex three dimensional configuration.

Yet another form of the present invention contemplates a green casting container comprising: a) high-purity ceramic particles; and b) a cured polymer-based binder holding the ceramic particles in the shape of a casting container, the green casting container does not contain more than trace amounts of silica.

Another form of the present invention contemplates a method for fabricating a casting container useful for casting reactive metals comprising: providing a mixture of high-purity ceramic particles with an uncured liquid polymer-based binder in a container, the mixture being free of silica; exposing selective areas of the mixture to a laser to form a green casting container of a cured polymer-based binder and ceramic particles; and, sintering the green casting container to adhere the adjacent ceramic particles and burn out the polymer binder to create a ceramic casting container.

Another form of the present invention contemplates a green casting container comprising: high-purity ceramic particles; and a cured polymer-based binder holding the ceramic particles in the shape of a casting container, the casting container does not contain more than trace amounts of silica.

In yet another form the present invention contemplates a casting container that may be used for forming a metal component, comprising: a plurality of high-purity ceramic particles sintered into the shape of a casting container form; and the casting container has a low reactivity with reactive metals and does not contain more than trace amounts of silica.

In yet another form of the invention, a liquid metal container is formed when an investment pattern is successively dipped into a ceramic slurry comprised of high purity ceramic particles and a curable polymer based binder. Subsequent to each successive dip, the polymer is cured from liquid to solid. The method of curing may be through UV radiation, IR radiation or heat, liquid sprays or controlled gaseous environments.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method for forming a cast component comprising:
providing a mixture including high-purity ceramic particles and a curable liquid polymer based binder, wherein the mixture is substantially free of silica;
exposing selective areas of the mixture to an energy dose from a laser to form a layer built green solid casting container;
sintering the green casting container to adhere the adjacent ceramic particles and burn out the polymer binder to create a hardened ceramic casting container free of silica;
pouring a reactive molten metal within the hardened ceramic casting container; and
solidifying the reactive molten metal to a cast component substantially free of defects associated with a reaction between the hardened ceramic casting container and the reactive molten metal.

2. The method of claim 1, wherein said exposing is carried out with multiple exposures to laser light.

3. The method of claim 1, wherein in said providing the high purity ceramic particles are particles of alumina and/or zirconia.

4. The method of claim 1, wherein in said providing the high purity ceramic particles are particles of yttria.

5. The method of claim 1, wherein in said providing the high purity ceramic particles are particles of Mullite.

6. The method of claim 1, wherein said exposing forms a green solid casting container including an interior volume including a complex three dimensional shape.

7. The method of claim 1, wherein said exposing forms a green solid casting container including at least one casting core.

8. The method of claim 7, wherein said at least one casting core is integrally formed with said green solid casting container.

9. The method of claim 1, wherein the hardened ceramic casting container is a mold.

10. The method of claim 1, wherein the defects that the cast component is substantially free of are alpha case defects.

11. The method of claim 1, wherein any defects are located within a region within 0.050 inches of an outer surface of the cast component.

12. The method of claim 1, wherein the defects that the cast component is substantially free of are alloy depletion defects.

13. A method for forming a cast component comprising:
providing a mixture including ceramic particles and a curable liquid polymer based binder;
forming a green solid casting mold from the mixture;
sintering the green casting mold to adhere the adjacent ceramic particles and burn out the polymer binder to create a sintered ceramic casting mold free of silica;
pouring a reactive molten metal within the sintered ceramic casting mold; and
solidifying the reactive molten metal to a cast component substantially free of surface defects associated with a reaction between the sintered ceramic casting mold and the reactive molten metal.

14. The method of claim 13, wherein said forming includes paste ceramic stereolithography.

15. The method of claim 13, wherein said forming includes gel casting.

16. The method of claim 13, wherein said forming includes stereolithography.

17. The method of claim 13, wherein said forming produces a green solid casting mold including an interior volume having at least a portion with a complex three dimensional shape.

18. The method of claim 13, wherein said forming produces a green solid casting mold including an interior volume having at least one portion that is not of a simple flat shape.

19. The method of claim 13, wherein said forming produces a green solid casting mold including at least one casting core.

20. The method of claim 19, wherein said at least one casting core is integrally formed with said green solid casting mold.

21. The method of claim 13, wherein the surface defects that the cast component is substantially free of are alpha case defects.

22. The method of claim 13, wherein any surface defects associated with the reaction between the ceramic and the reactive molten metal are located within a region within 0.050 inches of an outer surface of the cast component.

23. The method of claim 13, where the cast component is substantially free of alloy depletion defects.

24. An article, comprising:
an integrally cast titanium main body having and outer surface and at least one integrally formed internal opening therein, said outer surface as cast being substantially free of alpha case defects.

25. The article of claim 24, wherein said outer surface having at least a portion including a substantially complex three dimensional configuration.

26. A method for forming a cast component comprising:
(a) providing a mixture including high-purity ceramic particles and a curable liquid polymer based binder, wherein the mixture is substantially free of silica;
(b) dipping at pattern into the mixture to form a deposited layer;
(c) curing the deposited layer;
(d) sintering the green casting container to adhere the adjacent ceramic particles and burn out the polymer binder to create a sintered ceramic casting container free of silica;
(e) pouring a reactive molten metal within the sintered ceramic casting container; and
(f) solidifying the reactive molten metal to a cast component substantially free of defects associated with a reaction between the sintered ceramic casting container and the reactive molten metal.

27. The method of claim 26, which further includes repeating acts (b) and (c) multiple times prior to performing act (d).

28. The method of claim 26, wherein said curing includes exposure to Ultra Violet Radiation.

29. The method of claim 26, wherein said curing includes exposure to X-Ray Radiation.

30. The method of claim 26, wherein said curing includes exposure to Infra Red Radiation.

31. The method of claim 26, wherein said curing includes application of a liquid catalyst.

32. The method of claim 26, wherein said curing includes subjecting the green component being formed to a controlled gaseous environment.
